(19) United States
(12) Patent Application Publication
(10) Pub. No.: US 2021/0068477 A1
(43) Pub. Date: Mar. 11, 2021

(54) Illuminated Safety Vest with Integrated LED Lights

(71) Applicant: Claude A. Johnson, Chattanooga, TN (US)

(72) Inventor: Claude A. Johnson, Chattanooga, TN (US)

(21) Appl. No.: 16/834,295

(22) Filed: Mar. 30, 2020

Related U.S. Application Data
(60) Provisional application No. 62/898,697, filed on Sep. 11, 2019.

(51) Int. Cl. A41D 13/01; A41D 1/00

(52) U.S. Cl. CPC A41D 13/01; A41D 1/002

(57) ABSTRACT

An illuminated safety garment to improve the visibility of a wearer, such as a public service worker, in low-light conditions. The safety garment features an integrated LED light system that is electrically connected to a power source, and that ensure that the wearer is visible to third parties from a 360 degree vantage point. The LED light system may be hardwired or in wireless communication with an individualized or central controller that enables the user to control multiple aspects or features of the LED light system, as well as those of a number of other accessories such as an audible system, locator system, etc. Use of the illuminated safety garment offers a way to prevent serious accidents and injuries due to low visibility of, for example, public service workers.

### CROSS-REFERENCE TO RELATED APPLICATION

The present application claims priority to, and the benefit of, U.S. Provisional Application No. 62/898,697, which was filed on Sep. 11, 2019 and is incorporated herein by reference in its entirety.

### BACKGROUND

The present invention relates generally to illuminated safety apparel. More specifically, the present invention relates to a safety garment or vest featuring integrated LED lights and other accessories to improve the visibility of, for example, public service workers. Accordingly, the present specification makes specific reference thereto. However, it is to be appreciated that aspects of the present invention are also equally amenable to other similar applications.

Many public service workers, such as policemen, firemen, airport ramp workers, department of transportation personnel, construction workers, refuse collectors, military personnel, hunters, hikers, runners, cyclists, traffic directors, and others engaged in outdoor activities in limited visibility environments are subjected to unnecessary risks due to their ability to be easily seen by others. In order to mitigate or reduce such risks, many of such individuals will wear brightly colored or fluorescent style safety apparel or other clothing in an attempt to improve their visibility to, for example, oncoming motorists. More specifically, safety apparel has application for those working in high traffic areas, or at night or in other low light conditions (e.g., in a tunnel, under a bridge or overpass, etc.) when and where visibility is oftentimes poor or less than ideal. The main advantage provided by safety apparel is to improve the visibility of the safety apparel wearer to third parties from a greater distance, thereby providing the third parties with greater reaction time in which to take corrective action and to avoid coming into contact with the wearer. Corrective action can include increasing distance or separation from the wearer, or adjusting course so as to avoid coming into contact with the wearer altogether.

Unfortunately, safety apparel in the form of colored or fluorescent style vests or other clothing still require the presence of an external light source, which may not always be present. Accordingly, such apparel is of limited use in such instances and could result in serious injury or death to the wearer if, for example, an oncoming motorist does not see the wearer and strikes the wearer with his or her vehicle.

Therefore, there exists a long felt need in the art for a safety apparel device that can be used by an individual, such as a pedestrian, a bicyclist, policemen, firemen, airport workers, department of transportation personnel, construction workers, refuse collectors, military personnel, and the like, to increase the individual's visibility to third parties, such as oncoming motorists. There is also a long felt need in the art for a safety device that is self-illuminating, and that does not require the presence of an external light source, such as a headlight on an oncoming vehicle, to be seen. There is also a long felt need in the art for a safety device that, when illuminated, has 360 degree visibility, and is not dependent on the posture or positioning of the wearer to be seen. Finally, there is a long felt need for an improved and portable safety device, such as an illuminated safety vest, that is battery or solar powered, and that is both safe and easy to use.

The subject matter disclosed and claimed herein, in one embodiment thereof, comprises an improved safety garment in the form of a vest that greatly improves the visibility of the wearer to third parties regardless of the angular positioning of the third party relative to the wearer of the illuminated safety vest. The present invention discloses an improved safety vest that is comprised of a plurality of light emitting diode (LED) lights integrated therein, a controller for controlling the operation of said LED lights, and a portable power source for powering the LED lights. More specifically, the improved safety vest is preferably comprised of LED lights attached to the outer seams of the garment in both a generally horizontal and vertical fashion, and a means for turning on/off the lights, controlling their brightness, color, mode of operation, etc.

In this manner, the improved safety vest featuring integrated LED lights of the present invention accomplishes all of the forgoing objectives, thereby improving the visibility of the wearer to third parties regardless of the angular orientation of the wearer to the third party and is customizable to suit user need and/or preference. Use of the improved safety vest offers wearers a practical and inexpensive way to improve their visibility to others in poor visibility environments, and to reduce the likelihood of an accident that could result in serious injury or even death.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an improved safety vest that greatly improves the visibility of the wearer to third parties regardless of the angular positioning of the third party relative to the wearer of the safety vest. The improved safety vest is preferably comprised of a wearable garment, such as a vest, and a portable LED lighting system. The safety vest may include a pair of front panels, a rear panel, one or more pockets, openings for the neck, torso and arms of the wearer, fluorescent or other brightly colored striping, a closure mechanism for the front panels, and a plurality of outer seams helping to define said openings. Each of the outer seams may further comprise or support a plurality of LED lights, which may be woven into, or attached to, the outer seams. Further, the improved safety vest of the present invention may be available in various sizes and colors to accommodate all user needs and preferences. Exact size, measurement, construction, and design specifications may vary upon further development and manufacturing.

The portable LED lighting system is preferably comprised of one or more LED light strips each containing a plurality of LED lights in electrical communication therewith, a controller for controlling one or more features or attributes of the LED lights, and a power supply for powering the LED lights. More specifically, the improved safety vest of the present invention is comprised of a plurality of LED lights attached to the outer seams of the wearable garment in both a generally horizontal and vertical fashion to fully surround the wearer with LEDs for greater visibility, and to ensure that a third party onlooker can see the illuminated safety vest regardless of the angular positioning of the third party relative to the wearer of the safety vest. Further, the controller of the portable LED lighting system may further comprise an on/off switch for controlling power to the plurality of LED lights, and one or more other controls for affecting other attributes of the LED lights including, without limitation, brightness, mode of operation (e.g., continuous light, intermittent light, strobe effect lighting, etc.), color, etc.. The controller may be stored in one of the pockets of the garment for easy access by the wearer.

It is also contemplated that the improved safety vest or a plurality of improved safety vests in a particular area may be remotely and wirelessly controlled by a single controller via, for example, Bluetooth or RFID technologies. Additionally, the power supply may comprise a battery pack comprised of disposable or rechargeable batteries in electrical communication with the one or more LED light strips and the plurality of LED lights. Nonetheless, it is also contemplated that the power supply could be one or more solar or photovoltaic panels or cells, or any other power supply system capable of powering the LED lighting system and/or other accessories of the illuminated safety vest.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of the improved safety vest of the present invention in accordance with the disclosed architecture.

FIG. 2 illustrates a rear perspective view of one potential embodiment of the improved safety vest of the present invention in accordance with the disclosed architecture.

FIG. 3 illustrates a side perspective view of one potential embodiment of the improved safety vest in working condition and being worn by a user in accordance with the disclosed architecture.

FIG. 4 illustrates a rear perspective view of one potential embodiment of the improved safety vest in working condition and being worn by a user in accordance with the disclosed architecture.

FIG. 5 illustrates a perspective view of one potential embodiment of the controller of the present invention and in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

For individuals working in low-light environments, or participating in sports or hobbies during the nighttime, in close proximity to motor vehicles or other potential dangers, being visible can save them from accidents and or injury. Aspects of the present invention provide an improved safety garment in the form of a vest to be utilized or worn by individuals such as policemen, firemen, airport ramp workers, transportation personnel, construction workers, refuse collectors, military personnel, hunters, hikers, runners, cyclists, and any other users relying on enhanced visibility to ensure their safety.

As noted above, there exists a long felt need in the art for a safety garment that can be used by an individual to increase the individual's visibility to third parties. There is also a long felt need in the art for a safety device that is self-illuminating, and that does not require the presence of an external light source, such as a headlight on an oncoming vehicle, to be seen. There is also a long felt need in the art for a safety device that, when illuminated, has 360 degree visibility, and is not dependent on the posture or positioning of the wearer to be seen. The illuminated safety garment of the present invention satisfies all of the above referenced needs and more.

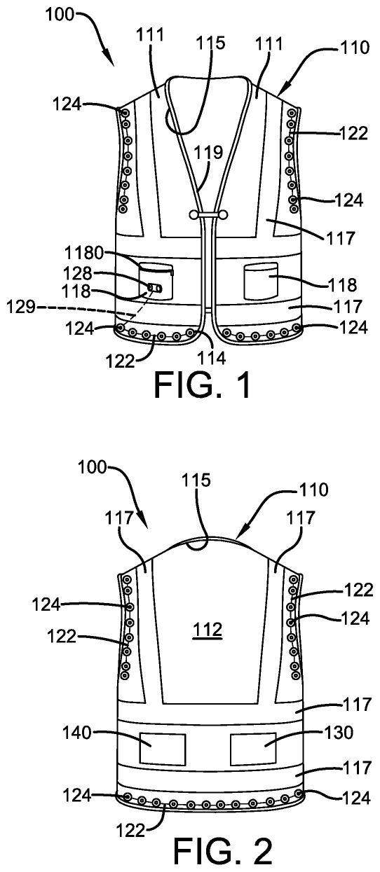

Referring initially to the drawings, FIG. 1 illustrates a front perspective view of one potential embodiment of the improved safety garment 100 of the present invention. Safety garment 100 is preferably comprised of a vest 110, and a LED lighting system 120. Vest 110 is preferably comprised of a pair of front panels 111 attached to a rear panel 112 and forming a torso opening 114, a neck opening 115 and a pair of arm openings 116, as best shown in FIGS. 1, 2 and 3. Vest 110 is preferably comprised of a brightly colored or fluorescent, breathable fabric such as cotton, chambray, rayon, linen, or the like. Nonetheless, it is contemplated that the fabric of the vest 110 can be manufactured from a variety of different materials and/or colors, and the vest 10 may be available in various sizes and colors to accommodate all user needs and preferences. Further, in a preferred embodiment of the present invention, one or more of front panels 111 and/or rear panel 112 are comprised of reflective striping 117, to increase the visibility of the vest 110 to others.

Vest 110 may also comprise a garment closure mechanism 119 for securing the two front panels 111 together after a user has put on the vest 110. For example, the garment closure mechanism 119 may be in the form of one or more adjustment straps that surround the wearer 200 of the vest 110 horizontally when the vest is adorned. The ends of each of the one or more adjustment straps 119 may be joined to each other by one or more buckles, clasps, or the like, or they may simply be tied together to secure the front panels 111 together. As used in the present disclosure a “strap” is preferably a strip of leather, cloth, nylon, plastic, or other flexible material, often with a buckle, that is used to fasten, secure, carry, or hold onto something. Additionally, vest 110 further comprises a plurality of outer seams 113 located around the outer edges of vest 110, and around the various openings (e.g., 114, 115 and 116), the importance of which will be further described below.

As best shown in FIGS. 1 through 4, LED lighting system 120 is preferably comprised of a LED strip 122, a plurality of LED lights 124, a controller 126, a power supply 128 and associated wiring 129. LED strip 122 may be an elongated strip of material for supporting a series of LED lights 124, and capable of being in electrical communication therewith. The LED strip 122 and the plurality of LED lights 124 located thereon are preferably located in or attached to the outer seams 113 of vest 110 to provide 360 degree visibility around the wearer 200. For example, FIGS. 1 and 2 depict LED strips 122 and LED lights 124 positioned along the outer seams 113 of the lower front and rear panels, 111, 112. respectively of vest 110, as well as around the front and rear of the arm openings 116. Nonetheless, it is also contemplated that additional LED strips 122 and LED lights 124 may also be positioned elsewhere along vest 110 including, without limitation, around neck opening 115 and the outer seams 113 of front panels 111 where they join together via closure mechanism 119.

The plurality of LED lights 124 can be of any suitable single or multiple colors, suitable uniform or variable sizes and are operated by the means of one or more switches (not shown) within controller 126. As used in the present disclosure, a “switch” refers to an electrical device that starts and stops, or otherwise modifies, the flow of electricity through an electric circuit by completing or interrupting an electric circuit. Completing or interrupting an electric circuit with a switch is often referred to as closing or opening a switch, respectively.

In one embodiment, the plurality of LED lights 124 may be waterproofed, either by placement of the plurality of LED lights 124 in, for example, one or more waterproof compartments with transparent windows (not shown) or by encapsulation of the LED lights 124, either partially or wholly, in a waterproof compound, coating or membrane. In another embodiment, the LED lights 124 may be smart LEDs, which work based on ambient light sensing, which turns on in dim or low light conditions, or at night. The LED lights 124 may also be controlled by a light sensor attached to or formed in LED strip 122. In this embodiment, the LED lights 124 will automatically turn on in a low light setting. More specifically, when electric power is supplied to the LED lights 124 and the amount of available light in the surrounding area is low enough, the LED lights 124 will automatically turn on, otherwise they will remain off to conserve battery life. Alternately, the LED lights 124 may be controlled based on the presence of light detected from the light sensor such that it turns on slowly in the evening as it gets darker outside and fades off in the morning as the amount of ambient light increases slowly.

As one skilled in the art will appreciate, LED light strip 122 and LED lights 124 may also be wired such that all LED lights 124 remain on in a well-defined state, flash simultaneously in a regular on and off pattern, flash in a fluctuating manner if required, flash simultaneously in a pattern of any number of quick flashes followed by an off state of longer duration before repeating the pattern of quick flashes, flash in any type of regular or irregular pattern to include specific codes, flash in a programmed or random sequence, or any combination or variation thereof to make the invention more clear and useful. The known circuitry and wiring 129 for controlling the LED lights 124 via controller 126, as described more fully below, is preferably located within vest 100, but may be located anywhere.

In a further embodiment of the present invention and for purposes of further increasing the visibility of safety vest 100, a fiber-optic thread 125 may be used for sewing or attaching the LED strips 122 and/or LED lights 124 into or onto vest 100. More specifically, fiber-optic thread receives electrical power from power supply 128, and may be sewn along the outer seams 113 of safety garment 100, or in any other pattern desired to increase the visibility of the garment 100. Exact size, measurement, construction, and design specifications may vary upon further development and manufacturing, and the LED lights 124 and/or fiber optic threads 125 can be provided in many different, commercially-available colors including, without limitation, red, blue, green, yellow, white, orange, or any combination thereof.

As previously indicated, controller 126 is used to control the operation of LED lights 124 and is in communication with LED strip 122 and LED lights 124, either via wiring 129 or wirelessly, as described more fully below. Controller 126 preferably comprises an on/off switch 1260, a brightness controller 1262, a mode controller 1264 and a color controller 1266. More specifically, on/off switch 1260 is used to provide or shut off power to the LED lights 124 and/or fiber optic threads 125 from power supply 128. The brightness controller 1262 allows the wearer 200 to control the brightness of the LED lights 124 and/or fiber optic threads 125, so that additional illumination is available on demand and so that less illumination may be specified by the wearer when not needed to conserve, for example, battery power.

Mode controller 1264 allows the wearer 200 to control the mode of operation of the LED lights 124 and/or fiber optic threads 125. For example, various modes of operation are contemplated including, without limitation continuous lighting, flash simultaneously in a regular on and off pattern, flash in a fluctuating manner if required, flash simultaneously in a pattern of any number of quick flashes followed by an off state of longer duration before repeating the pattern of quick flashes, flash in any type of regular or irregular pattern to include specific codes, flash in a programmed or random sequence, or any other combination or variation thereof to make the invention more clear and useful. Similarly, color controller 1266 may be used by the wearer 200 to change the color of the LED lights 124 and/or fiber optical threads 125 for example, by changing the color of all such lights 124 and threads 125, or by selectively activating only those LED lights 124 and threads 125 of a certain color.

Notwithstanding, it is also contemplated that controller 126 may be a central controller that is capable of controlling the LED lights 124 and fiber optic threads 125 of multiple safety garments 100 at the same time, via wireless technology such as Bluetooth or RFID and a smart device (not shown) such as a mobile phone. For example, a project foreman may be able to control the operation of the safety garments 100 of his or her entire construction crew via a single central controller 126.

Power supply 128 may be used to provide power to improved safety vest 100 and its various components via wiring 129. More specifically, power supply 128 may be comprised of a battery, a solar panel, a photovoltaic panel, or other suitable power source. If a battery is used, it may be a disposable battery or a rechargeable battery, and may be easily replaced or removed if necessary, for recharging. In one embodiment, safety vest 100 contains a battery pack located in a pouch sewn to the interior of the vest 110. The batteries can be selected from disposable batteries or rechargeable batteries; preferably double-A sized batteries in sufficient quantity to provide power to a maximum number of LED lights 124 and/or fiber optic threads 125. Suitable batteries include alkaline, nickel-cadmium, nickel-metal hydride, etc. In one embodiment, alternate power sources may also be used such as solar power cells electrically connected to solar panels (not shown) secured to the illuminated safety vest 100. More specifically, the solar panel will be charged during daylight and will provide power to the LED lights 124 and fiber optic threads 125 at night or in other low light environments. Throughout this specification the terms “battery”, “battery pack”, and “batteries” may be used interchangeably to refer to one or more wet or dry cells or batteries of cells in which chemical energy is converted into electricity and used as a source of DC power. References to recharging or replacing batteries may refer to recharging or replacing individual cells, individual batteries of cells, or a package of multiple battery cells as is appropriate for any given battery technology that may be used.

As best shown in FIG. 1, vest 110 may further comprise one or more pockets 118 having a corresponding pocket closure mechanism 1180 for securing any contents that may be placed in the pockets 118, such as controller 126 and/or power supply 128. As used in the present disclosure, a “pocket” refers to a storage space or pouch that is formed into an object, such as vest 110. Pockets 118 may be formed by joining a second textile or a second sheeting to a first textile or a first sheeting, respectively, by sewing, heat sealing or other like means. As shown in FIG. 1, pockets 118 are preferably located on the exterior surface of one or both of front panels 111, though it is contemplated that pockets 118 may also be located on an interior surface of either or both of front panels 111, or elsewhere along vest 110 to suit user need and/or preference.

The pockets 118 are adapted for holding controller 126 and/or power supply 128. For example, in one embodiment of the present invention, a wearer 200 may press a marked location on the pocket 118 to activate one or more features of the controller 126 within the pocket 118, for example, in order to activate and deactivate the LED lights 124. In another embodiment, the wearer 200 may insert his/her hand inside the pocket 118 to activate one or more features of the controller 126. As previously stated, the pocket 118 also includes a pocket closure mechanism 1180 for securing and protecting the contents of pocket 118. The pocket closure mechanism 1180 may be in the form or a flap or other closure means such as hook and loop fasteners, snaps, buttons, zippers, tape, or any other similar means.

In a further preferred embodiment of the present invention, the safety garment 100 may provide additional features to draw attention to the presence of the wearer 200 such as an audible alarm 130 that may be triggered by the wearer 200 or some external event. The audible alarm 130 may be located along the rear panel 112 of the garment 100, as shown in FIG. 2, or at any other location to suit user need and/or preference. The audible alarm 200 may be powered by the power supply 128 via wiring 129, or have its own power supply, such as a battery pack. Finally, the operation of the audible alarm 130 may also be controlled by controller 126.

In a further preferred embodiment, the safety garment 100 may also comprise a locator module 140. The locator module 140 may be a Global Positioning System (GPS), or other location system capable of providing information about the geographic location of the garment 100 and the wearer 200 donning the same. For example, first responders may remotely acquire information about the location of the wearer 200 based upon wireless signals that the locator module receives and responds to from external sources to enable the first responders to quickly locate the wearer 200. The locator module 140 may be located along the rear panel 112 of the garment 100, as shown in FIG. 2, or at any other location to suit user need and/or preference. The locator module 140 may be powered by the power supply 128 via wiring 129, or have its own power supply, such as a battery pack. Finally, the operation of the locator module 140 may be controlled by controller 126.

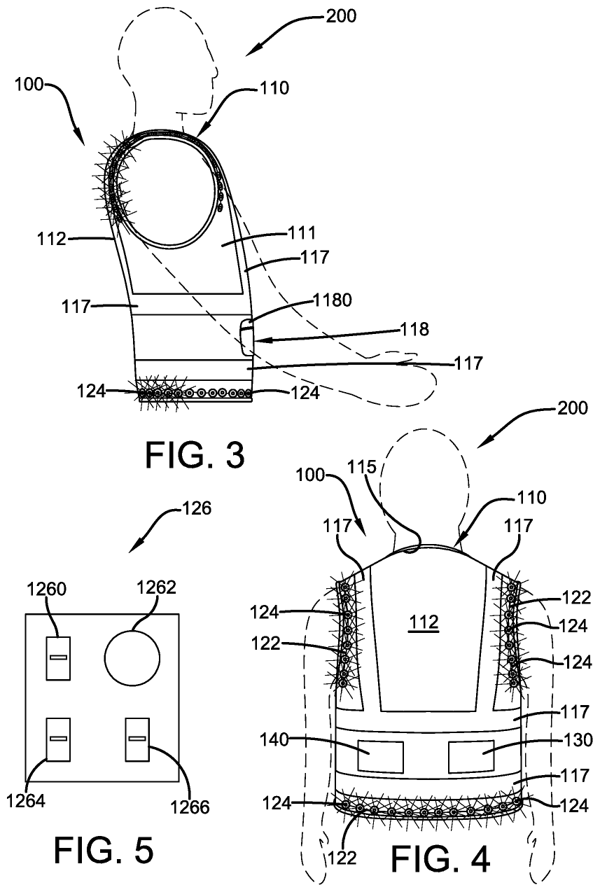

FIG. 3 illustrates a side perspective view of one potential embodiment of the improved safety vest 100 in working condition and being worn by a user 200 in accordance with the disclosed architecture, and FIG. 4 illustrates a rear perspective view of one potential embodiment of the improved safety vest 100 in working condition (i.e., partially illuminated) and being worn by user 200.

Embodiments of the present invention not only provide increased safety, but also increased utility through flexible options and features, which are easy to operate and provide convenience to the wearer 200. It should be understood by those skilled in the art that while the description contained herein utilizes a vest to illustrate embodiments of the present invention, the invention is equally applicable to other garments which can be used for safety purpose such as jogging or walking suits or shorts, pants, shirts, sweatshirts, hats or other such articles of clothing.

Notwithstanding the forgoing, the illuminated safety garment 100 of the present invention and its various structural components can be any suitable size, shape, and configuration as is known in the art without affecting the overall concept of the invention, provided that it accomplishes the above stated objectives. One of ordinary skill in the art will appreciate that the shape and size of the illuminated safety garment 100 and its various components, as show in the FIGS. are for illustrative purposes only, and that many other shapes and sizes of the safety garment 100 are well within the scope of the present disclosure. Although the dimensions of the safety garment 100 are important design parameters for good performance, the safety garment 100 and its components may be any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A safety garment comprising:
a garment;
an LED lighting system attached to said garment;
a power supply; and
a controller.

2. The safety garment of claim 1, wherein the garment is comprised of a pair of front panels, a back panel, a neck opening, a torso opening, a pair of arm openings and a striping.

3. The safety garment of claim 1, wherein the garment is further comprised of a plurality of outer seams.

4. The safety garment of claim 3, wherein the LED lighting system is attached to the plurality of outer seams.

5. The safety garment of claim 1, wherein the LED lighting system is comprised of a LED strip and a plurality of LED lights attached to said strip in series.

6. The safety garment of claim 5, wherein the plurality of LED lights are in electrical communication with the power supply.

7. The safety garment of claim 1, wherein the power supply is one of a battery pack, a solar panel and a photovoltaic panel.

8. The safety garment of claim 1, wherein the controller further comprises at least one of an on/off switch, a brightness adjuster, a color selector and a mode selector.

9. The safety garment of claim 8, wherein the brightness adjuster controls a brightness of the LED lighting system.

10. The safety garment of claim 8, wherein the color selector controls a color of a light emitted from the LED lighting system.

11. The safety garment of claim 8, wherein the mode selector controls a mode of operation of the LED lighting system.

12. The safety garment of claim 8, wherein the mode of operation is comprised of a select one of: (a) a continuous light; (b) and intermittent light; and (c) a strobe light.

13. A safety garment comprising:
a vest;
an LED lighting system attached to said vest and that is visible from a vantage point that is located anywhere around the vest; and
a power supply for powering the LED lighting system.

14. The safety garment of claim 13, wherein the LED lighting system is comprised of a LED strip and a plurality of LED lights attached to said strip.

15. The safety garment of claim 13, wherein the power supply is one of a battery pack, a solar panel and a photovoltaic panel.

16. The safety garment of claim 13 further comprising a controller having an on/off switch, a brightness adjuster, a color selector and a mode selector.

17. The safety garment of claim 16, wherein the brightness adjuster controls a brightness of the LED lighting system, the color selector controls a color of a light emitted from the LED lighting system, and the mode selector controls a mode of operation of the LED lighting system.

18. The safety garment of claim 17, wherein the mode of operation is comprised of a select one of: (a) a continuous light; (b) and intermittent light; and (c) a strobe light.

19. A safety garment comprising:
a vest comprised of a pair of front panels, a back panel, a neck opening, a torso opening, a pair of arm openings and a striping;
an LED lighting system attached to said vest, wherein the LED lighting system is comprised of a LED strip and a plurality of LED lights attached to said LED strip;
a power supply for powering the LED lighting system;
a controller for controlling the operation of the LED lighting system;
an audio alarm; and
a locator device.

20. The safety garment of claim 19, wherein the LED lighting system is visible from a vantage point that is located anywhere around the vest.
